(19) United States
(12) Patent Application Publication
(10) Pub. No.: US 2025/0285199 A1
(43) Pub. Date: Sep. 11, 2025

(54) GENERATING ENERGY WINDOWS

(71) Applicant: Apple Inc., Cupertino, CA (US)

(72) Inventors: Ian Falcon, Solana Beach, CA (US); Brian J. Tucker, San Jose, CA (US); Nicholas A. Russo, Rancho Mission Viejo, CA (US); Joelle L. Lam, Los Altos Hills, CA (US); Lauren Hannah, Kensington, CA (US); Elizabeth A. Watson, Silver Spring, CA (US); Andrea R. Romano, San Francisco, CA (US); Kristina B. Stanford, San Francisco, CA (US)

(73) Assignee: Apple Inc., Cupertino, CA (US)

(21) Appl. No.: 19/077,001

(22) Filed: Mar. 11, 2025

Related U.S. Application Data
(60) Provisional application No. 63/563,764, filed on Mar. 11, 2024.

(51) Int. Cl. G06Q 50/06; G06Q 30/0201

(52) U.S. Cl. CPC G06Q 50/06; G06Q 30/0206

(57) ABSTRACT

Techniques are described for generating energy interval notifications. An example can include a computing system configured to access generation source information, grid conditions information, and price information. The computing system can generate forecasted values based at least in part on historical information, where the forecasted values are generated for a first time interval. The computing system can also determine an energy forecast for the first time interval, where the energy forecast is based at least in part on the forecasted rate and the forecasted values.

### CROSS-REFERENCES TO RELATED APPLICATIONS

This application claims priority under 35 U.S.C. § 119(e) to U.S. Provisional Application Ser. No. 63/563,764, filed Mar. 11, 2024, entitled “GENERATING ENERGY WINDOWS,” which is incorporated herein by reference in its entirety.

### BACKGROUND

A computing system can collect information related to energy production of an energy provider. The computing system can further use the information to output an energy production analysis to improve energy production and delivery of energy to consumers.

### BRIEF DESCRIPTION OF THE DRAWINGS

FIG. 1 is an illustration of a system for an energy notification service, according to one or more embodiments.

FIG. 2 is a process flow generating an energy forecast, according to one or more embodiments.

FIG. 3 is an illustration of an example system for energy forecast generation, according to one or more embodiments.

FIG. 4 is an illustration of an example energy forecast system, according to one or more embodiments.

FIG. 5 is an illustration of an example generation source time interval, according to one or more embodiments.

FIG. 6 is an illustration of an example grid condition time interval, according to one or more embodiments.

FIG. 7 is an illustration of an example price time interval, according to one or more embodiments.

FIG. 8 is an example use of the energy time interval service, according to one or more embodiments.

FIG. 9 is a process flow for generating an energy forecast, according to one or more embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

An electrical grid can include transmission and distribution lines that connect energy providers (e.g., power plants) and consumers (e.g., home, business, etc.). The energy providers can generate electricity using traditional non-renewable sources and/or renewable sources. These renewable resources can be integrated into the electrical grid as distributed generation, which refers to small-scale renewables (rooftop solar panels or local community solar arrays), and centralized, utility-scale generation, which refers to large scale projects (e.g., large, commercial wind farms and/or large, commercial solar panel arrays).

Electricity supply and consumer demand must always be equal. The energy providers can deliver the generated electricity over high-voltage transmission and distribution lines that carry the electricity to the consumers. The difference between the supply of electricity provided by renewable sources and consumer demand can be made up through electricity provided by non-renewable sources or dispatched from energy storage systems. To satisfy consumer demand, the electrical grid operators can determine the amount of renewable energy that is being produced at any given time, an expected amount of renewable energy that will be produced, and how to respond to shifts in renewable energy production. Today generally, the consumer demand for electricity exceeds the electricity produced through renewable resources and all renewable energy generated is used. However, in some instances, consumer demand can drop below a production capacity, and production from renewable energy may then either be stored or curtailed.

On the other side, consumers can draw electricity to power their homes and devices. However, the consumers can be unaware if the electricity that is being provided to their homes and devices is being generated through renewable sources or non-renewable sources. Non-renewable energy sources can contribute to carbon dioxide emissions and other greenhouse gases. Different non-renewable energy sources can emit different levels of emissions into the atmosphere. Coal combustion can result in the highest carbon dioxide emissions of the non-renewable energy sources. In addition, burning coal can result in the emission of sulfur dioxide, nitrogen dioxide, and particulates. Burning oil can result in less carbon dioxide emission than coal, but it can still contribute to greenhouse gases in the atmosphere. Natural gas may be considered one of the non-renewable energy sources that produce the least amount of carbon dioxide, sulfur dioxide, and nitrogen oxide. Renewable energy sources, on the other hand, can be characterized as not generating emissions during the production of electricity. However, today most consumers are unaware of the sources of the electricity that is being provided by an electrical grid and how those sources vary throughout the day and year. If the consumer was aware of the source of the electricity, in some examples, the consumer may modify their behavior to use electricity at a time when the providers are providing electricity that has been generated by either renewable energy sources or non-renewable energy sources that produce lower amounts of emissions than other non-renewable energy sources (e.g., if the consumer cares about the environment or otherwise wants to reduce pollution). However, today its rarely known by the consumer what type of electricity is being provided at any given time.

Embodiments herein address the above-referenced issues by providing techniques for a computing service to receive real-time information from multiple sources and provide real-time and localized energy optimization suggestions.

A computer system (e.g., a service) may receive data from various sources to generate the energy optimization suggestions. For example, the service may receive grid condition data, price data, and/or generation source data. This data may identify various signals that the service may use to best provide the energy optimization suggestions. Examples of generation source data include data solar generation forecast data, wind generation forecast data, or the like. Examples of grid condition data include marginal emission rates, grid loads, average emissions, curtailment probabilities, coincident peak, flex alerts, or the like. Price data can include customer rate plans, locational marginal pricing (LMP), region average LMP, or the like.

To illustrate, the service may determine time intervals for when renewable energy is being curtailed, time intervals for when renewable energy is being produced, and/or time intervals for when cleaner energy sources are being used for marginal energy production, or the system may determine other information such as, for example, time intervals for when renewable energy is cheaper to produce than other time intervals. The data, or signals, received may be combined and/or compared against additional data (e.g., historical data) to optimize energy usage and/or to generate the energy optimization suggestions.

In an example, the service may receive grid condition data from a grid condition database. The grid condition data may indicate the current usage status of a given energy grid. For example, the current usage status could indicate that renewable energy is being curtailed at a given time interval. The current usage status may be received by the service as a first signal. Another signal may be pricing, or utility rate data received from a price data database. The pricing data may indicate that energy prices are lower than average due to lower consumer demands at the given time interval. The combined usage status signal and the pricing data signal may, for example, be compared to historical data relating to usage status and pricing data. If the service determines that energy usage during the time interval would be cleaner and cheaper when compared to the historical data, then the service may generate a user interface notification to be presented on a user device, for example, to encourage a user to utilize energy during the time interval. In another example, the service may receive grid condition data from a grid condition database. The grid condition data may indicate a grid's hourly load or may be provided as a grid alert such as a Flex Alert or Energy Emergency Alert. For example, the current load status could indicate that the energy demand on the grid is increasing and may be approaching the grid's annual coincident peak. The current load status may be compared to the grid's historical load data. If the service determines that the current load exceeds a threshold compared to the historical load data, then the service may generate a user interface notification to be presented on a user device, for example, to encourage a user to avoid utilizing energy during the time interval.

More specifically, the computing system (e.g., a service) can compare the information to threshold values to determine an energy time interval (e.g., a window) that indicates a best time for consuming energy via using (e.g., turning on, interacting with, charging, etc.) electrical devices. The goal is that use of electricity during this time interval avoids high emission times and promotes renewable energy production. The service can further cause the energy time interval to be presented to a user via a user device (e.g., a smartphone or smartwatch) by displaying energy windows corresponding to the determined energy time intervals. The energy windows may be presented/displayed on the device within a timeline to provide the user with a perspective of a particular time (e.g., a time of day) when energy usage is cleaner than other times of a day. In other embodiments, the timeline may represent a longer or shorter time period than a day. The user can view the information and choose to modify their behavior. For example, the user can choose to consume energy (e.g., power their electrical devices) during the energy windows if the energy windows are correlated with renewal energy being available. If a grid load increases during energy window periods, an energy grid operator may be incentivized to demand that renewable energy source producers generate more electricity using cleaner energy sources.

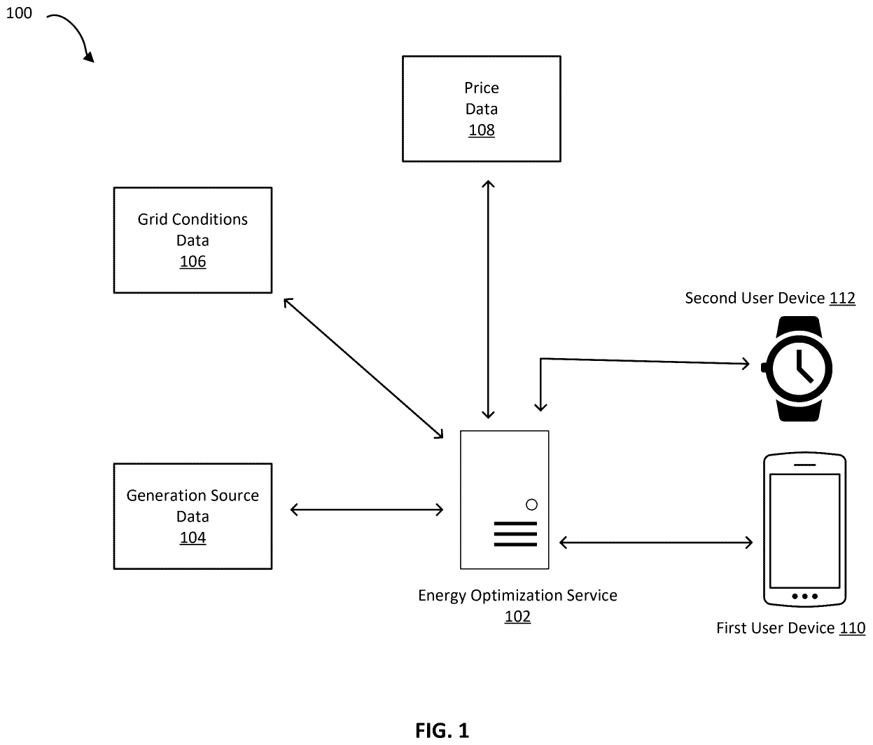

FIG. 1 is an illustration 100 of a system for an energy window notification service 102, according to one or more embodiments. An energy window notification service 102 can receive various types of data from various sources and generate an energy forecast. For example, the energy window notification service 102 can receive generation source data 104. Generation source data 104 can include data from various renewable energy and non-renewable energy providers (e.g., power plants). An example of a non-renewable energy provider is a fossil fuel plant.

A fossil fuel plant can generate electricity through the combustion of some form of fuel (e.g., coal, natural gas, or oil). The amount of gas emitted during the combustion process can be based on the fuel that is used and the efficiency of the fossil fuel plant. Some fossil fuel plants can only have the capability to use one type of fuel. Other fossil fuel plants can have the capability to use different types of fuel during the combustion process. These fossil fuel plants can use different fuels based on various parameters, such as regulations, fuel availability, and grid load. Renewable energy providers can include solar power plants and wind power plants. A solar power plant can generate electricity through a photovoltaic effect. The solar power plant can include one or more solar panels that each include photovoltaic cells. Each photovoltaic cell can absorb photons from sunlight and use the photons to generate electricity. Solar energy can be considered renewable energy based on the use of sunlight for the energy production process. Furthermore, the solar power plant can generate electricity without emitting carbon dioxide or other greenhouse gases. A wind power plant can use wind to generate electricity through the use of wind turbines. Similar to solar energy, wind energy can be considered a renewable energy based on the use of wind to rotate the generator and generate electricity. Furthermore, the wind power plant can generate electricity without emitting carbon dioxide or other greenhouse gases.

It should be appreciated that various other types of generation sources (e.g., hydroelectric, nuclear, geothermal, and tidal) can provide generation source data 104 to the energy window notification service 102. For example, a hydroelectric energy provider can generate energy via the flow of water turning a turbine. A tidal energy provider can generate energy based on the rise and fall of tidal currents turning a turbine. A geothermal power plant can generate energy from naturally occurring heat, steam, and hot water within the earth. A nuclear power plant can generate energy by using nuclear fusion reactions to generate steam that turns a turbine.

The energy window notification service 102 can receive various amounts of data from one or more generation sources of the energy providers. The information can include, for example, the amount of electricity being produced, emissions, emissions rates, generation rates, and heat input.

The energy window notification service 102 can also receive grid conditions data 106. Grid conditions data 106 can include, for example, load information, flex alert information, weather information, curtailment, and transmission constraint information. Load information can include the demand for electricity during various times during the day. For example, the load information can include time series data over a time interval. The flex alert information can include data and times when flex alerts are issued. A flex alert can be a notification/suggestion for consumers to conserve electricity in anticipation of an electricity shortage. Additionally, in instances where a flex alert is used, no threshold values would be needed, as the flex alert can act as a valid energy window. This is at least because thresholds may be primarily used with signals that are continuous and that are desired to be mapped into a binary space. On the other hand, flex alerts are already mapped into a binary space. In some instances, using flex alerts and peak load signals in combination, could help prevent windows during the worst times to use energy. The weather information can include, for example, various weather related parameters, such as temperature, humidity, cloud coverage, and precipitation information. The weather information can also be in the form of time series data. Transmission constraint information can include the measure of energy that an energy provider can provide to an area. The measure of energy can be based on various parameters, such as a capacity of a network to deliver the energy to an area demanding the energy.

The energy window notification service 102 can also receive price data 108. The price data 108 can be affected by various factors. For example, energy pricing can be affected by, for example, consumer demand, availability of energy sources, fuel costs, energy provider operating costs. The demand for electricity can fluctuate throughout the day. For example, in residential areas, the demand for electricity can be highest before people generally leave for work and when people generally return home. Additionally, the demand for electricity can be lower at night and during the day. Seasonally, the demand for electricity can be the highest during the months that record the highest average temperatures (e.g., peak summer) or the months that record the lowest average temperatures (e.g., peak winter).

If the renewable energy plants are providing electricity such that total electricity received by the power grid greatly exceeds the customer demand, the power grid systems can become overwhelmed. Additionally, if the power grid is receiving renewable energy, such that total electricity (e.g., renewable energy based and non-renewable energy-based) received by the power grid greatly exceeds the customer demand, the power grid operators may not be willing to pay much for the electricity. Therefore, it may cost a renewable energy plant more to generate electricity than it can recoup in compensation.

The power grid's operators attempt to balance the supply of electricity from the providers with the demand for electricity from the customers. Renewable energy is dependent on the source (e.g., wind or sunlight), which can be unpredictable. Therefore, renewable energy production can be curtailed during times of excess electricity supply. Renewable energy curtailment can be the intentional limitation of the output of electricity generated through renewable sources into a power grid. In other words, a solar energy plant, or a wind energy plant can elect to curtail their output, or the power grid operators can notify them to curtail their output when supply exceeds demand. In some examples, when the signals for renewable energy curtailment overlap with the signals for peak renewable energy generation, improved energy windows can be generated. Additionally, avoid window notifications may be generated (and sent to user devices for presentation) based on signals that identify high emissions and peak load overlapping. Similarly, an avoid window notification could be generated when peak time of use (TOU) and peak load overlap.

Marginal generation can occur in instances where demand begins to exceed supply. Marginal generation can refer to the power grid operators using a specific source of electricity to meet an incremental demand at a given point in time. In other words, marginal generation is the selection of the next power source to use to meet an incremental increase in demand. The power grid operators can select the next power plant based on various factors. For example, the power grid operators can select the next power plant based on which provider has the lowest costs associated with generating the electricity. The power grid operators determine that there is an increase in the demand for electricity, and can further determine that the power grid is receiving electricity from the non-renewable energy provider. The power grid operators can compare the costs associated with different renewable energy providers. The power grid operators can further select the renewable energy providers associated with the lowest costs at the current time.

Under the same idea, in time when the energy demands decrease, the power grid operators can take the power plant that has the highest costs offline. For example, the power grid can receive electricity from the various non-renewable energy providers and renewable energy providers. At some point in time, the power grid can experience a drop in the demand for electricity. The power grid operators can compare the costs associated with the various non-renewable and renewable energy providers. The power grid operators can further take one or more of the non-renewable and renewable energy providers associated with the highest costs offline.

The data received by the energy window notification service 102 can include analog data in the form of one or more time series, for example, dates and times that renewable energy is curtailed, dates and times that renewable energy is generated, dates and times for different marginal generation rates, and any other appropriate data. The data can be historical data that can be used to forecast future dates and times. In some instances, the energy window notification service 102 can use a machine learning model that implements a forecasting technique (e.g., autoregressive integrated moving average (ARIMA), exponential smoothing, gradient boosting, Prophet) or a forecasting service and access forecasted values using the historical data. In some instances, the energy window notification service 102 provides forecasted values along with the historical data. In addition to the forecasted values, the forecasting data can include various forecasting parameters identified by the machine learning model or information service. The forecasting parameters can include, for example, seasonality, trends, outliers, and other appropriate parameters.

The energy window notification service 102 can use the historical data and the forecasted data to make predictions as to the next occurrence of an energy time interval. In some examples, the energy window notification service 102 can generate one or more threshold values to compare against the data. The energy window notification service 102 can then compare the data to the threshold to convert the analog data into an energy forecast that can assume binary format.

The energy window notification service 102 can use the historical data and the forecasted data to determine a respective threshold probability, for example, generation source information, grid condition information, and price information. The energy window notification service 102 can compare the probability at each point in time (e.g., a data point for each minute, a data point for each hour) with the threshold probability. For example, if the energy window notification service is comparing the threshold to forecasted probabilities for each minute of the data, the energy window notification service 102 can be configured to identify an energy time interval as including 240 consecutive candidate data points for an energy time interval (e.g., a block of data points within a four hour interval). In some instances, a block includes a set number of data points within an interval of time, and in other instances, a block can be any number of data points.

The energy window notification service 102 can further use the comparison of the threshold to the data points to generate an energy forecast that indicates different time periods that are considered energy time intervals. For example, the energy window notification service can forecast twenty-four hours of a future date. The forecast can include an indication of whether each hour of the twenty four hours is an energy time interval or not. The example above related to generating an energy time interval that indicates a renewable energy curtailment time period. It should be appreciated that the energy window notification service 102 can be configured to generate energy time intervals indicative of time periods associated with other energy characteristics.

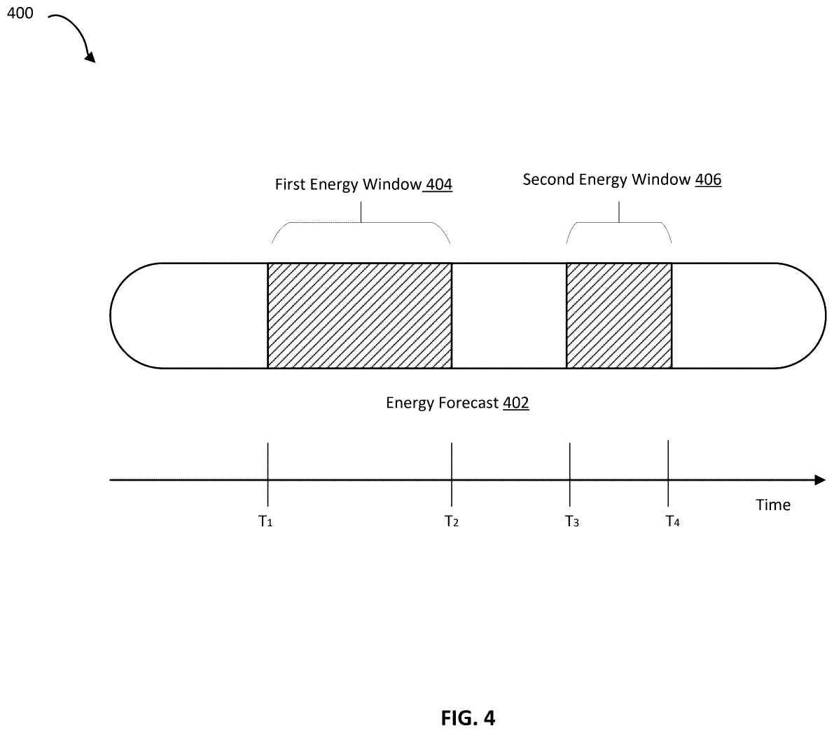

The energy window notification service 102 can further transmit the energy forecast to a first user device 110. The first user device 110 can be associated with an account of a customer of the power grid. The first user device 110 can further present the energy forecast to the user in the form of user interface representations of the energy time intervals. The energy time interval representations may be displayed as blocks of energy windows along a timeline as shown in FIG. 4. In other embodiments, other visual representations of the energy time intervals may be displayed such as a message indicating the best energy usage time or other similarly displayed indications. The user can elect to use the energy forecast to manage their energy usage. For example, the user can elect to use or recharge user devices only during identified energy time intervals. If enough users manage their behavior based on energy time intervals, the power grid operators can modify their behavior. For example, if there is a spike in demand during a traditional renewable energy curtailment period, the power grid operators may elect to not curtail renewable energy production during that time period.

In some instances, the first user device 110 can be associated with a smart home platform (e.g., Apple HomeKit) and the user may have associated multiple user devices with the smart home platform. For example, the first user device 110 is a smart phone and a second user device 112 is a smart watch, in which both devices are associated with the smart home platform. In this example, the energy window notification service 102 can transmit the energy forecast to both the first user device 110 and the second user device 112.

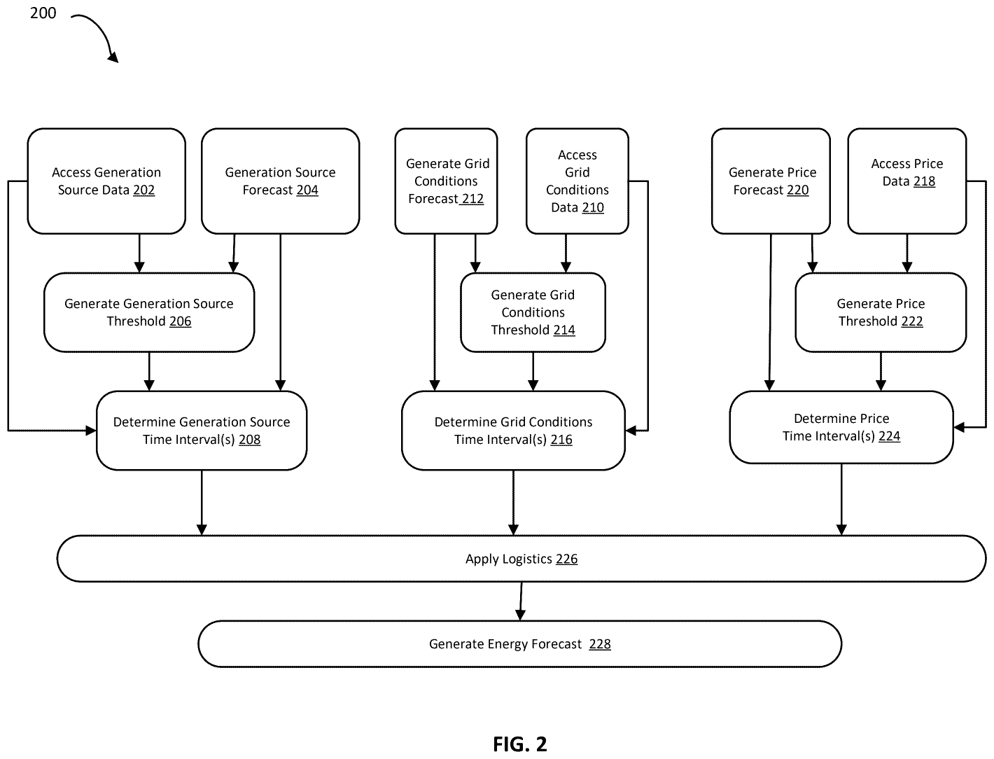

FIG. 2 is a process flow 200 generating an energy forecast, according to one or more embodiments. While the operations of processes 200 and 900 are described as being performed by generic computers, it should be understood that any suitable device may be used to perform one or more operations of these processes. Processes 200 and 900 (described below) are respectively illustrated as logical flow diagrams, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

At 202, a computing system, such as a server supporting an energy window notification service, can access information regarding the generation source data (e.g., information regarding non-renewable and renewable energy production information). An example of generation source data can include a rate at which an energy provider produces non-renewable energy and renewable emissions. For example, for an energy provider the rate may be expressed as gram (g) of CO₂ emitted per Kilowatt hour (kWh) of energy produced. In some instances, the information is known as a marginal operating emissions rate (MOER). This information can be dependent upon the area in which the user is to receive the forecast. For example, if the user is located in a region that relies on a mix of power that heavily favors coal or other fossil fuels, then the rate may be higher than if the user lives in a region that relies on a more balanced mix of non-renewable energy and renewable energy. The rate can also fluctuate throughout the day. For example, during midday, as an energy provider is generating solar energy, the MOER may decrease due to the availability of renewable energy. Therefore, the computing system can continuously receive information regarding the rate for each new unit of energy that is generated.

In addition to the current and historical data accessed at 202, the computing system can forecast generation source data at 204. For example, the computing system can use a first machine learning model that implements a forecasting technique (e.g., autoregressive integrated moving average (ARIMA), exponential smoothing, moving averages). The first machine learning model can be in the form of a convolutional neural network (CNN) and can be trained to generate a forecast generation source values. The machine learning model can take the information accessed at 202 and generate an output including the forecast. The forecast can be for a configurable time interval. For example, the computing system can use the machine learning model to forecast, for example, the next six hours, a next day, and a next week.

At 206, the computing system can generate a threshold based on the historical information and the forecast generation source information The generation source threshold can be repeatedly generated for various time periods. For example, the generation source threshold can be generated every six hours, each day, each week. In some embodiments, the computing system can generate the generation threshold based on the forecasting time interval. For example, if the forecasting time interval is one day, the generation source threshold can be determined each day.

The generation source threshold can define the energy forecast that is to be transmitted to a user device. The energy forecast indicates a time interval in which the electricity is being produced using cleaner means of production. An example energy forecast is described in more detail with respect to FIG. 4. The computing system can generate a generation source threshold that can be used to define time periods of the day in which the electricity is being produced using cleaner means of production. For example, the higher the value is, the more non-renewable emissions are being generated. The generation source threshold can define a rate such that a value higher than the generation source threshold is indicative of electricity being produced using less clean means of production. Additionally, a value lower than the threshold is indicative of electricity being produced using cleaner means of production.

In addition to being configured to regularly determine the threshold (e.g., determine the generation source threshold each day), the computing system can be configured to compute the generation source threshold based on the forecasted values. For example, during the summer and winter months, the average daily energy consumption can be high due to users using electricity for heating or cooling devices. Additionally, during the fall and spring months, the average daily energy consumption can be lower based on users turning their heating and cooling devices off. Therefore, the computing system can determine a generation source threshold in the winter and summer months that is higher than the generation source threshold in the spring and fall months.

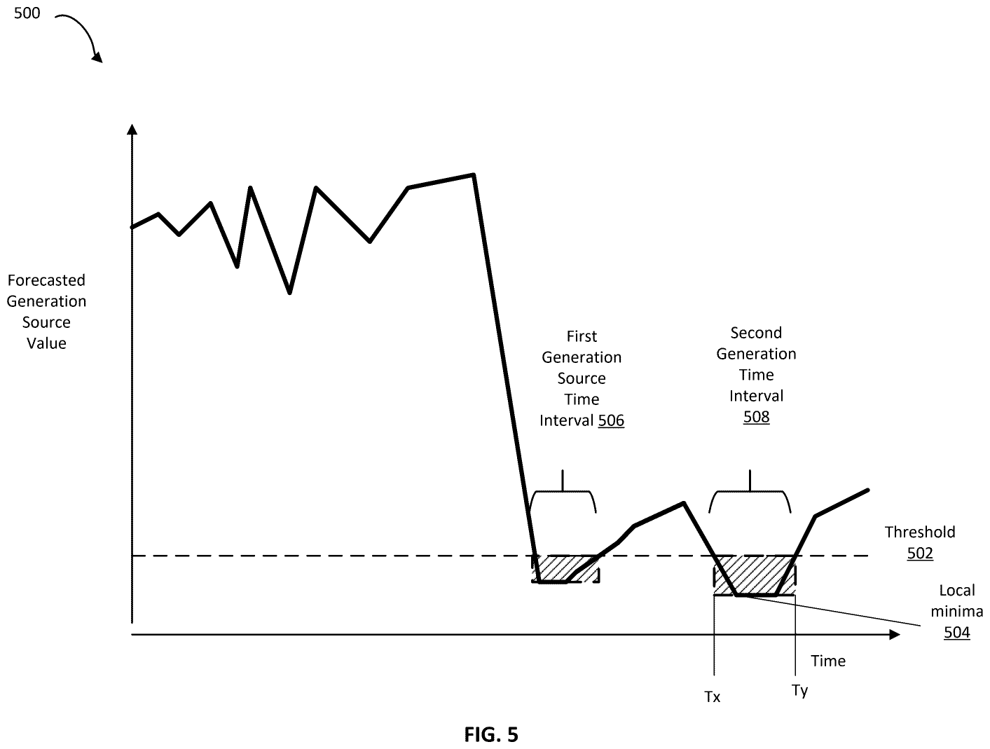

At 208, the computing system can generate the generation source time interval(s) using data from at least one, or a combination of, the access source data, the generation source forecast data, or the generation source threshold data. An example generation source time interval is described in more detail with respect to FIG. 5.

It should be appreciated that in some embodiments, the computing system may not generate a threshold. In other words, the generation source data and the generation source forecast can be used to generate the generation source time interval without the generation source threshold.

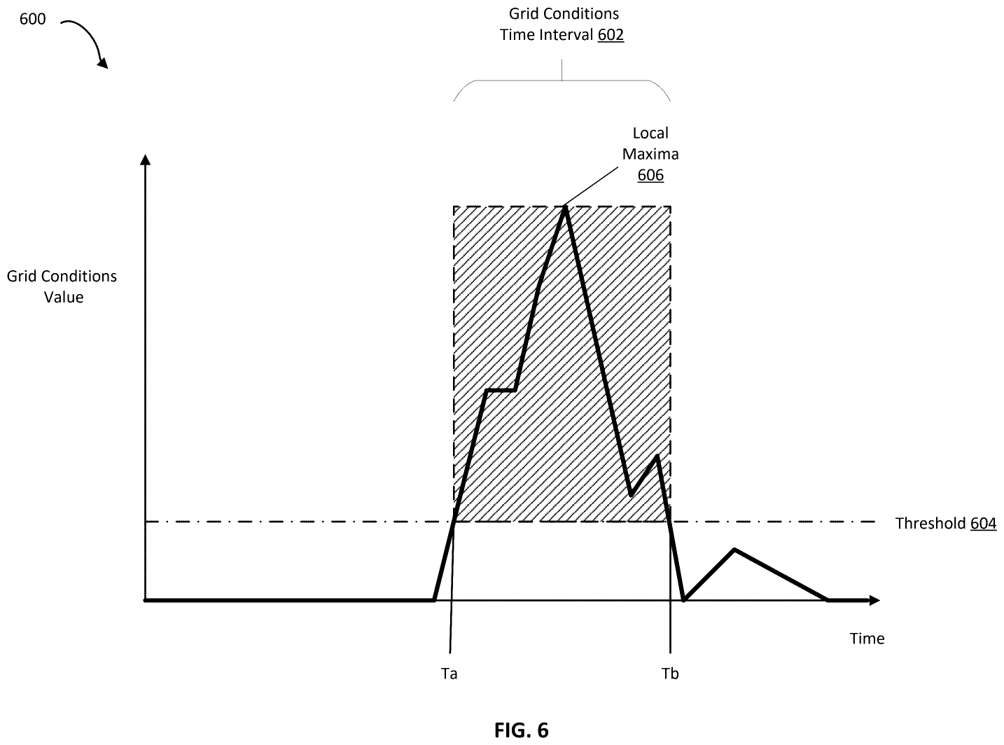

In conjunction with generating the generation source energy time interval, the computing system can generate a grid condition time interval, where a grid condition can include, for example, load, flex alert, weather, curtailment, and a transmission constraint. An example grid condition time interval is described in more detail with respect to FIG. 6. In some instances, the computing system can perform the steps to generate the grid condition time interval in parallel to the generation source time interval. At 210, the computing system can access historical grid condition data. The grid condition data can be associated with a grid that provides power in the user's region. The historical grid condition information can be accessed from various sources, such as directly from a database, or from a service. The grid condition information can be temporal information, such as hourly information, daily information, weekly information, monthly. The grid condition information can also include curtailment information per season (e.g., winter, spring, summer, and fall). The information can also include curtailment trend data and change point data.

At 212, the computing system can generate a grid condition forecast. For example, the computing system can use a second machine learning model that implements a forecasting technique. The second machine learning model can be in the form of a CNN and can be trained to generate a grid condition forecast. The second machine learning model can generate an input using the information accessed at 210. The second machine learning model can further generate an output, including the forecast. The forecast can be for a configurable time interval.

At 214, the computing system can generate a grid condition threshold based on the historical grid condition data and the grid condition forecast. The computing system can plot the grid condition forecast against a time interval. For example, the computing system can plot the grid condition forecast against the hours of a day. The grid condition threshold can be generated at a given frequency (e.g., once a day). The frequency for generating the grid condition threshold can correspond to the time interval of the forecast. For example, if the grid condition forecast time interval is one day, then the frequency of generating the grid condition threshold can also be one day. It should be appreciated that in some embodiments the computing system may not generate a threshold. In other words, the grid conditions data, and the grid conditions forecast can be used to generate the grid conditions time interval without the generation grid conditions threshold.

At 216, the computing system can determine a grid condition time interval. As indicated above, the computing system can plot the grid condition probability against a time interval. The computing system can further use the grid condition threshold to map a probability that exceeds the grid condition threshold to various time intervals. For example, if the grid condition is curtailment, a user can be encouraged to use an electrical device in periods that the energy provider is likely to curtail generation of renewable energy. As the demand for power increased during periods that energy providers have typically curtailed renewable energy generation, the energy providers may be encouraged to not curtail the generation of renewable energy.

At 218, the computing system can access price data. The price data can be accessed from a database of price data or a service that provides price data. The price data can include, for example, a time series of energy prices from an energy provider that provides energy for a user.

At 222, the computing system can use the price data to generate a price forecast. For example, the computing system can use a third machine learning model that implements a forecasting technique. The forecasting technique can be the same or a different technique than used above. The third machine learning model can be in the form of a CNN and can be trained to a forecasting technique to generate a price forecast. Similar to above, the price forecast can be for a configurable time interval. It should be appreciated that in some embodiments, the computing system may not generate a threshold. In other words, the price data, and the price forecast can be used to generate the price time interval without the generation source threshold.

At 224, the computing system can generate a price threshold. The price threshold can be based on, for example, a target energy price that a user would be willing to pay for energy generated, at least partially, through renewable energy sources. The threshold can be based on various factors, for example, consumer confidence, average energy prices, inflation rates, interest rates, or other appropriate factors. As the factors can vary with time, the price threshold can be continuously determined. The price threshold can be generated at a given frequency (e.g., once a day). The frequency for generating the price threshold can correspond to the time interval of the forecast. It should be appreciated that in some embodiments the computing system may not generate a threshold. In other words, the access price data and/or the generated price forecast can be used to determine price time interval without the price threshold.

At 226, the computing system can apply logistics to the generation source time interval, the grid condition time interval, and the price time interval. The logistics can be implemented by a set of computing instructions for defining an energy forecast. For example, the computing system can normalize the time frame of the generation source time interval, the grid condition time interval and the price time interval. In the instance that each of the generation source time interval, the grid condition time interval, and the price time interval are for twenty-four hours, the computing system may not need to take any further action. However, in the chance that the time frames of the time intervals are different, the computing system can normalize the time interval's time frame to each other. For example, if the generation source time interval's time frame was twelve hours (e.g., 8:00 a.m. to 8:00 p.m.), and the grid condition time interval and the price time interval's time frame were both twenty-four hours (e.g., 12:00 a.m. to 12:00 a.m.), the computing system can overlay the grid condition and price time interval onto the generation source time interval from 8:00 a.m. to 8:00 p.m.

At 228, the computing system can generate the energy forecast. Based on the determination of step 226, the computing system can generate control instructions for a user device. The control instructions can include the visual characteristics as to how the elements of the energy forecast are to be displayed.

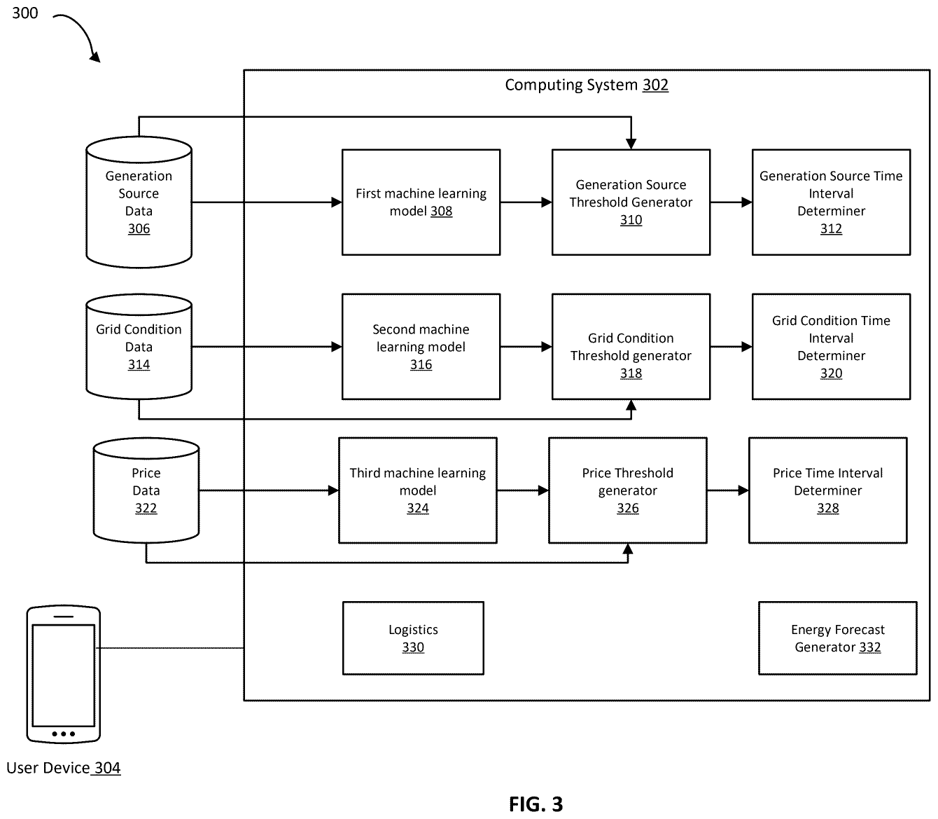

FIG. 3 is an illustration of an example system for energy forecast generation, according to one or more embodiments. A computing system 302 can be operable to receive generation source data, grid condition data, and price data. The computing system 302 can further use the data to generate an energy forecast. The computing system 302 can further transmit the energy forecast to be displayed on a user device 304.

The computing system 302 can access the generation source data, from a generation source data database 306. The computing system 302 can use the generation source data to generate inputs for first machine learning model 308, which can include a neural network (e.g., a CNN) for forecasting values for a given time interval (e.g., one day). For example, the computing system 302 can access hourly generation source data from 2010 to 2011 from the database 306. The generation source data can be particular to an energy provider that services a region, in which the user device 304 is located. The first machine learning model 308 can use a forecasting technique to output forecasted hourly values for, for example, Jan. 1, 2012, based on the data from 2010 to 2011.

The first machine learning model 308 can transmit the forecasted values to a generation source threshold generator 310. The generation source threshold generator 310 can generate a plot of forecasted generation source values against time. The generation source threshold generator 310 can generate a threshold generation source value. The threshold can define a desired time interval. For example, computing system can be configured to determine a time interval, in which an electrical device can draw power from an energy provider and the marginal operating emissions rate at the time indicates that fewer non-renewable emissions are being generated. The computing system can further be configured to set the threshold to be associated with a minimum time interval to permit the electrical device to have power to perform some operation. For example, a five minute time interval may not be helpful as most electrical devices are used for more than five minutes. A threshold associated with an hour can be useful as an electrical device can perform many functions within one hour.

The generation source threshold generator 310 can transmit the threshold to the generation source time interval determiner 312. The generation source time interval determiner 312 can use the threshold to determine each forecasted generation source value and each associated time point to include in a generation source time interval.

The computing system 302 can access the grid condition data from a grid condition data database 314. The computing system 302 can use the grid condition data to generate inputs for second learning model 316, which can include a neural network (e.g., a CNN) for forecasting grid condition values for a given time interval (e.g., one day). For example, the computing system 302 can access hourly grid condition data from 2010 to 2011 from the database 314. The grid condition data can be particular to an energy provider that services the region, in which the user device 304 is located. The second machine learning model 316 can use a forecasting technique to output forecasted hourly grid condition values for, for example, Jan. 1, 2012, based on the data from 2010 to 2011. Therefore, both the first machine learning model 308 and the second machine learning model 316 can forecast values for the same day (e.g., Jan. 1, 2012).

The second machine learning model 316 can transmit the forecasted grid condition values to a grid condition threshold generator 318. The grid condition threshold generator 318 can generate a plot of forecasted grid condition values against time. The grid condition threshold generator 318 can generate a threshold grid condition value. The threshold can define a desired time interval, which can be the same time interval as used for the generation source threshold.

The grid condition threshold generator 318 can transmit the threshold to the grid condition time interval determiner 320. The grid condition time interval determiner 320 can use the threshold to determine each forecasted grid condition value and each associated time point to include in a grid condition time interval.

The computing system 302 can access price data from a price data database 322. The computing system 302 can use the price data to generate inputs for a third machine learning model 324 that is trained to forecast energy prices for a time interval (e.g., Jan. 1, 2012). The third machine learning model 324 can transmit the forecasted values to a price threshold generator 326. The price threshold generator 326 can generate a plot of forecasted prices against time. The price threshold generator 326 can generate a threshold price value. The threshold can be used to define a desired time interval.

The generation source time interval determiner 312, the grid condition time interval generator 320, and the price time interval determiner 328 can transmit their respective time intervals to a logistic unit 330. The logistics unit 330 can determine what information is to be displayed on an energy forecast. As the generation source time interval, the grid condition time interval, and the price time interval, may or may not overlap, the logistics unit 330 can use a set of rules to reconcile the overlaps between the generation source time interval(s), the grid condition time interval(s), and the price time interval(s), when they occur. Additionally, a rate window (e.g., time interval) and a curtailment window (e.g., time interval) may or may not overlap, and the logistics unit 330 can further use the set of rules to reconcile the overlap.

The logistics unit 330 may consider various scenarios for determining whether to include information in an energy forecast. A first scenario can include a generation source time interval overlapping with a grid condition time interval and/or a price time interval. A second scenario can include a generation source time interval overlapping with a time interval different from the grid condition time interval and/or a price time interval. A third scenario can include a grid condition time interval overlapping with a time interval that is different from the generation source time interval and/or a price time interval. A fourth scenario can include a time interval with no price time interval overlapping a time interval with a grid condition time interval and/or a generation source time interval. A fifth scenario can include a time interval with no generation source time interval overlapping a time interval with a grid condition time interval. The logistics unit 330 can resolve the first scenario by including a time interval associated with an overlapping generation source time interval and grid condition time interval and/or price time interval in the energy forecast as a time interval that optimizes renewable energy use. The logistics unit 330 can further resolve the fifth scenario by including the time interval associated with no generation source time interval and no grid condition time interval and/or price time interval as a time interval that does not optimize renewable energy use.

For the second, third, and fourth scenarios, the logistics unit 330 can perform additional analysis. For example, the logistics unit 330 can score the generation source data points included in the generation source time interval based on a distance from the threshold, where the greater the distance, the greater the score. The logistics unit 330 can then compare the aggregate score of each of the data points and compare the aggregate score to a threshold score. If the aggregated score is greater than the threshold score, then the logistics unit 330 and include the generation source time interval in the energy forecast. Similarly, the logistics unit 330 can score the grid condition data points included in the grid condition time interval based on a distance from the threshold, where the greater the distance, the greater the score. The logistics unit 330 can then compare the aggregate score of each of the data points and compare the aggregate score to a threshold score. If the aggregated score is greater than the threshold score, then the logistics unit 330 and include the grid condition time interval in the energy forecast. Again, the logistics unit 330 can score the price data points included in the price time interval based on a distance from the threshold, where the greater the distance, the greater the score. The logistics unit 330 can then compare the aggregate score of each of the data points and compare the aggregate score to a threshold score. If the aggregated score is greater than the threshold score, then the logistics unit 330 and include the price time interval in the energy forecast. The logistics unit 330 can transmit its determinations to the energy forecast generator 332, which can generate control instructions for displaying an energy forecast on the user device 304. The computing system 302 can transmit the control instruction to the user device 304, which can use the instructions to display the energy forecast.

Additionally, in some examples, the logistics unit 330 may determine that the generation source time interval overlaps the grid condition time interval, in which case, the logistics unit 330 may be configured to cause the energy forecast to be presented based at least in part on the overlap, where the energy forecast includes the indication of timing for usage of energy that is provided by the energy provider, and where the indication of the timing of the usage of the energy is within at least one of a first time interval or a second time interval. Further, in other examples, the logistics unit 330 may determine that the generation source time interval overlaps the price time interval over a third time interval, in which case, the logistics unit 330 may be configured to cause the energy forecast to be presented based at least in part on the overlap, where the energy forecast includes the indication of timing for usage of energy that is provided by the energy provider, and where the indication of the timing of the usage of the energy is within at least one of the first timer interval, the second time interval, or the third time interval.

FIG. 4 is an illustration 400 of an example presentation of an energy forecast on a device, according to one or more embodiments. The presented energy forecast 402 can include a visual representation of one or more user interface elements corresponding to energy windows (e.g., indications of timing of using of energy). The energy forecast can be presented on a user device, such as via an energy widget, a notification badge on a mobile device, an audio notification, or in a home automation application. As illustrated, the energy forecast 402 includes a first user interface element corresponding to a first energy window 404 spanning from T₁ to T₂. The energy forecast 402 further includes a second user interface element corresponding to a second energy window 406 spanning from T₃ to T₄. The first energy window 404 and the second energy window 406 can indicate times which are favorable for renewable energy based on information from the generation source time interval and/or the grid condition time interval. The gaps between the energy windows (e.g., the time spanning from T₂ to T₃) indicate times that are not favorable to renewable energy production. For example, the first energy window 402 and/or the second energy window 404 can correspond to a curtailment time interval, and if during this period users were to use their electrical device, an energy provider may be discouraged to curtail renewable energy generation. For example, if the user demand for power during the first energy window exceeds the supply of energy, a provider may continue to generate renewable energy to meet the demand.

FIG. 5 is an illustration of an example generation source plot 500, according to one or more embodiments. As illustrated FIG. 5 describes a plot in which values above the threshold 502 are not beneficial to renewable energy usage, and values below the threshold 502 are beneficial to renewable energy usage. A computing system can generate a plot 500 of forecasted generation source value against time. The plot 500 can indicate a generation source time interval based on a threshold 502. To generate the threshold 502, the computing system can determine a local minima 504 in the plot. The local minima 504 can correspond to a forecasted generation source value (e.g., y-axis value). The computing system can set the threshold 502 based on determining a desired time interval (e.g., one hour). The desired time interval can be defined as T_{y}−Tₓ, where Tₓ and T_{y} are time points along the x-axis of the plot 500. The computing system can determine a set of forecasted value points that correspond to a time interval defined by T_{y}−Tₓ and include the local minima 504. The threshold can correspond to the end points (e.g., the forecasted values at Tₓ and T_{y}) of the set of forecasted value points. As illustrated, this can result in a first generation source time interval 506 and a second generation source time interval 508. As indicated above, the threshold can be updated regularly. Therefore, in periods of high energy use, such as summer and winter, the threshold 502 may be higher than as illustrated in FIG. 5. In this sense, the energy time interval can indicate times that are beneficial for the promotion of renewable energy sources and reflect the current usage characteristics.

FIG. 6 is an illustration of an example grid condition plot 600, according to one or more embodiments. A computing system can generate a plot 600 of the forecasted grid condition value against time. The plot 600 can indicate a grid condition time interval 602 based on a threshold 604. To determine the threshold 604, the computing system can determine a local maxima 606. The computing system can then determine a threshold 604. The local maxima 606 can correspond to a forecasted grid condition value (e.g., y-axis value). The computing system can set the threshold 604 based on determining a desired time interval (e.g., two hours). The desired time interval can be defined as T_{b}−Tₐ, where Tₐ and T_{b} are time points along the x-axis of the plot 600. The computing system can determine a set of the forecasted value points that correspond to a time interval defined by T_{b}−Tₐ and include the local maxima 606. The threshold 604 can correspond to the end points (e.g., the forecasted curtailment probability values at Tₐ and T_{b}) of the set of forecasted value points.

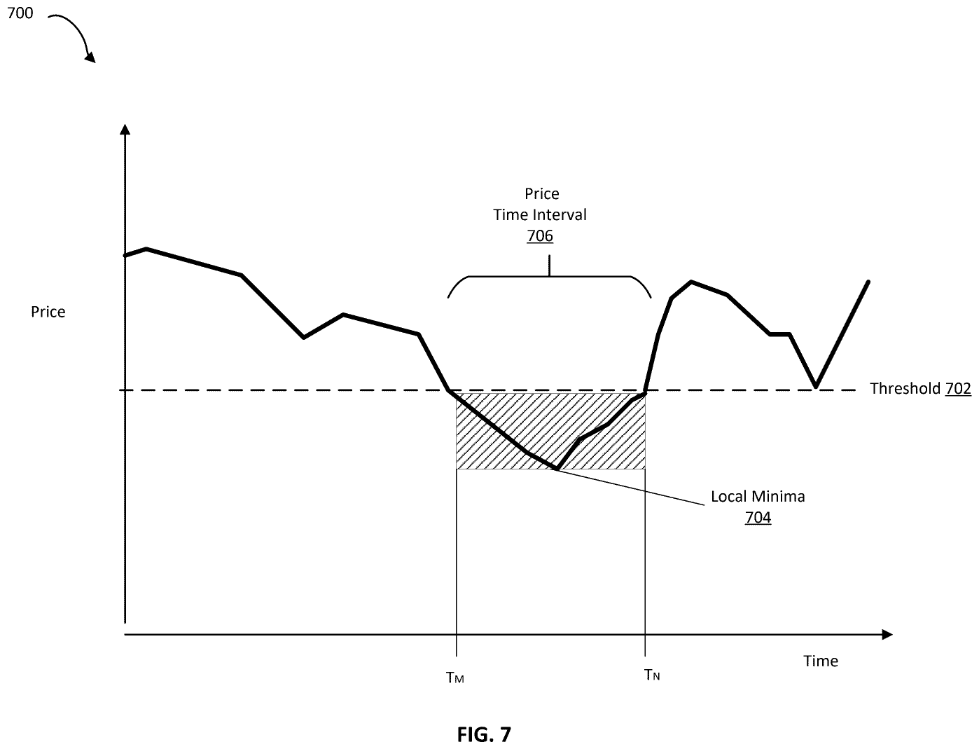

FIG. 7 is an illustration of an example price plot, according to one or more embodiments. A computing system can generate a plot 700 of forecasted price values against time. The plot 700 can indicate a price time interval based on a threshold 702. To generate the threshold 702, the computing system can determine a local minima 704 in the plot. The local minima 704 can correspond to a forecasted price value (e.g., y-axis value). The computing system can set the threshold 702 based on determining a desired time interval (e.g., one hour). The desired time interval can be defined as T_{M}−T_{N}, where T_{M} and T_{N} are time points along the x-axis of the plot 700. The computing system can determine a set of forecasted value points that correspond to a time interval defined by T_{M}−T_{N} and include the local minima 704. The threshold 702 can correspond to the end points of the set of forecasted value points.

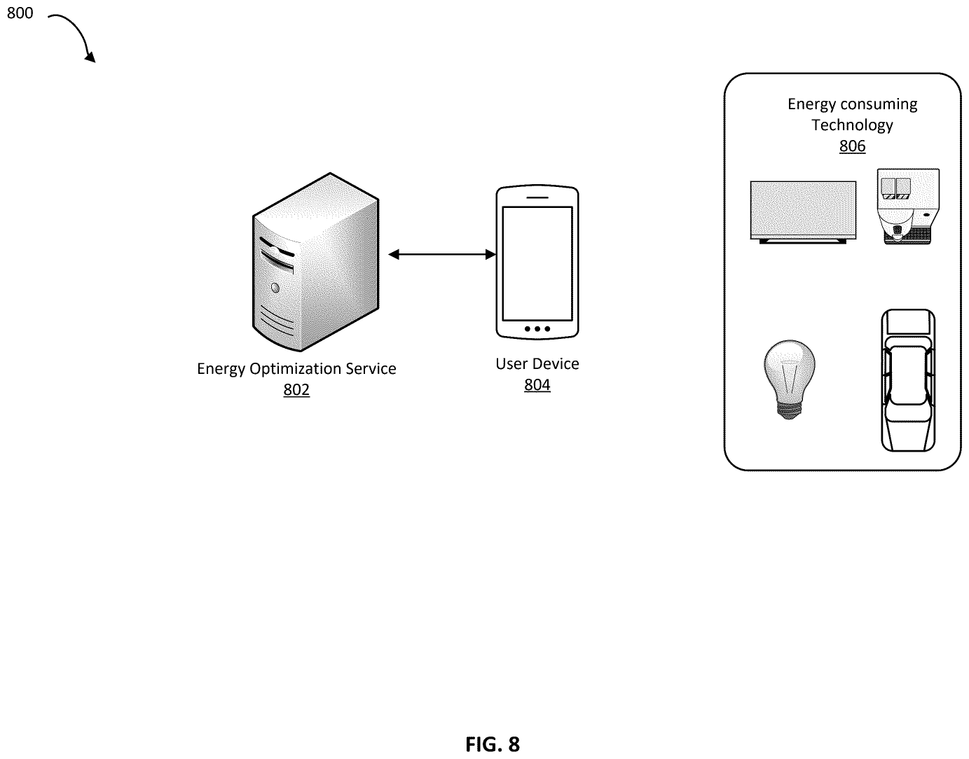

FIG. 8 is an illustration 800 of an example use of the energy window notification service, according to one or more embodiments. An energy window notification service 802 can receive energy information and generate an energy forecast. The energy forecast can be transmitted to the user device 804. The user device can display the energy forecast, which presents windows of times that a user can use and/or charge an electrical device 806 in a manner to promote the use of renewable energy. A user can own one or more instances of energy consuming technology. Based on the energy forecast, the user can elect to use these electrical devices at a time indicated by the energy forecast.

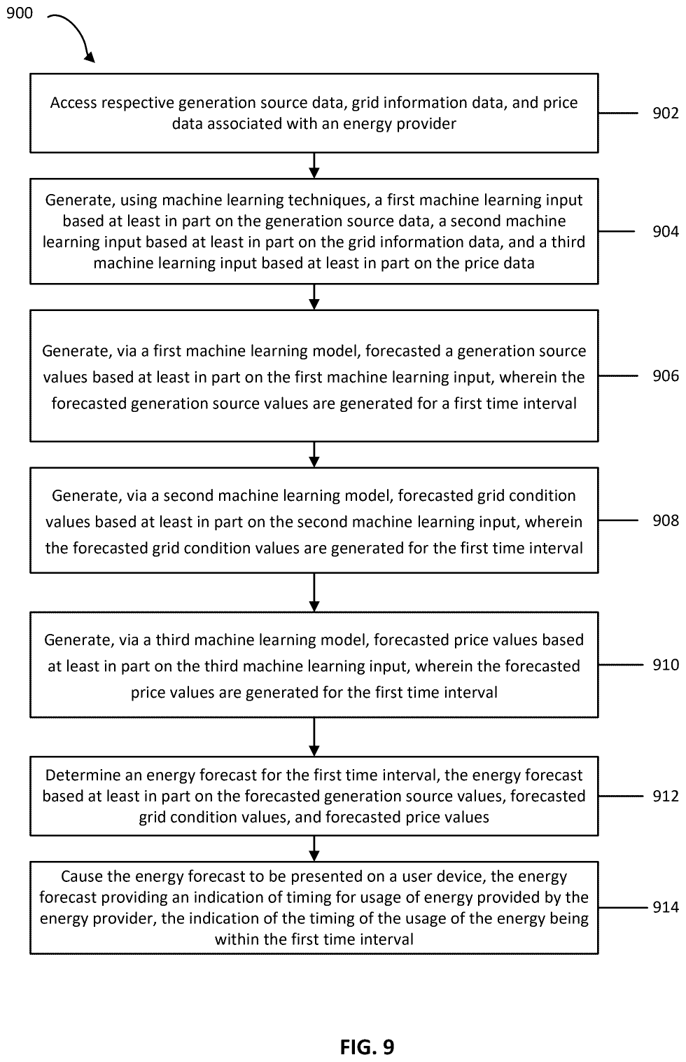

FIG. 9 is a process flow 900 for generating an energy forecast, according to one or more embodiments. At 902, the method can include a computing system accessing generation source data, grid information data, and price data associated with an energy provider. The generation source data can include MOER information, the grid condition data can include curtailment information, and the pricing data and including energy pricing information. At 904, the method can include the computing system generating, using machine learning techniques, a first machine learning input based at least in part on the generation source data, a second machine learning input based at least in part on the grid information data, and a third machine learning input based at least in part on the price data.

At 906, the method can include the computing system generating, via a first machine learning model, forecasted generation source values based at least in part on the first machine learning input. The first machine learning model can be trained to forecast generation source values. The forecasted generation source values can be generated for a first time interval.

At 908, the method can include the computing system generating, via a second machine learning model, forecasted grid condition values based at least in part on the second machine learning input. The second machine learning model can be trained to forecast grid condition values. The forecasted grid condition values can be generated for the first time interval.

At 910, the method can include the computing system generating, via a third machine learning model, forecasted price values based at least in part on the third machine learning input. The third machine learning model can be trained to forecast pricing values. The forecasted price values are generated for the first time interval.

At 912, the method can include the computing system determining an energy forecast for the first time interval, the energy forecast based at least in part on the forecasted generation source values, forecasted grid condition values, and forecasted price values. The energy forecast can describe renewable energy information in binary format. For example, the energy forecast can describe times, in which using electrical devices promotes renewable energy generation, and times, in which using electrical devices does not promote renewable energy generation.

At 914, the method can include the computing system causing the energy forecast to be presented on a user device, the energy forecast providing an indication of timing for usage of energy provided by the energy provider, the indication of the timing of the usage of the energy being within the first time interval. For example, the computing system can generate control instructions for causing the user device to present the energy forecast. The computing system can further generate updated control instructions each time that a threshold is generated to accurately reflect the current energy windows.

The energy forecast notification system can cause the energy forecast to be presented on a user device in a number of different manners including displaying notifications on a locked screen of a device such as banners, and/or presenting audio indications of the forecast, and/or in-app notifications, and the like. In one embodiment, the energy forecast is presented within a home automation control app including controls for managing energy usage within a home. In this way, a user is able to act on the energy forecast in an easy and intuitive manner within the home automation control app.

Although specific embodiments have been described, it will be appreciated that embodiments may include all modifications and equivalents within the scope of the following claims.

As described above, one aspect of the present technology is the gathering and use of data available from specific and legitimate sources to improve the delivery of messages from one device to one or more devices. The present disclosure contemplates that in some instances, this gathered data may include personal information data that uniquely identifies or may be used to identify a specific person. Such personal information data may include demographic data, location-based data, online identifiers, telephone numbers, email addresses, home addresses, date of birth, or any other personal information.

The present disclosure recognizes that the use of such personal information data, in the present technology, may be used to the benefit of users. For example, the personal information data may be used to deliver a command from a user profile on a computing device to one or more computing devices. Further, other uses for personal information data that benefit the user are also contemplated by the present disclosure.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities may subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements may be provided to prevent or block access to such personal information data. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk may be minimized by limiting the collection of data and deleting data once it is no longer needed. In addition, and when applicable, including in certain health related applications, data de-identification may be used to protect a user's privacy. De-identification may be facilitated, when appropriate, by removing identifiers, controlling the amount or specificity of data stored (e.g., collecting streaming data without collecting account information), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments may also be implemented without the need for accessing such personal information data. That is, the various embodiments of the present technology are not rendered inoperable due to the lack of all or a portion of such personal information data. For example, content may be selected and delivered to users based on aggregated non-personal information data or a bare minimum amount of personal information, such as the content being handled only on the user's device or other non-personal information available to the content delivery services.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein may be implemented on the same processor or different processors in any combination. Accordingly, where components or modules are described as being configured to perform certain operations, such configuration may be accomplished, e.g., by designing electronic circuits to perform the operation, by programming programmable electronic circuits (such as microprocessors) to perform the operation, or any combination thereof. Processes may communicate using a variety of techniques, including but not limited to conventional techniques for inter-process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein may be performed in any suitable order unless otherwise indicated herein or otherwise clearly contradicted by context. The use of any and all examples, or exemplary language (e.g., “such as”) provided herein, is intended merely to better illuminate embodiments, and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments may be utilized in any number of environments and applications beyond those described herein without departing from the broader spirit and scope of the specification. The specification and drawings are, accordingly, to be regarded as illustrative rather than restrictive.

What is claimed is:

1. A method, comprising:
accessing, by a computing system, generation source data, grid information data, and price data associated with an energy provider;
generating, by the computing system and using machine learning techniques, a first machine learning input based at least in part on the generation source data, a second machine learning input based at least in part on the grid information data, and a third machine learning input based at least in part on the price data;
generating, by the computing system and via a first machine learning model, forecasted generation source values based at least in part on the first machine learning input, wherein the forecasted generation source values are generated for a first time interval;
generating, by the computing system and via a second machine learning model, forecasted grid condition values based at least in part on the second machine learning input, wherein the forecasted grid condition values are generated for the first time interval;
generating, by the computing system and via a third machine learning model, forecasted price values based at least in part on the third machine learning input, wherein the forecasted price values are generated for the first time interval;
determining, by the computing system, an energy forecast for the first time interval, the energy forecast based at least in part on the forecasted generation source values, the forecasted grid condition values, and the forecasted price values; and
causing, by the computing system, the energy forecast to be presented on a user device, the energy forecast providing an indication of timing for usage of energy provided by the energy provider, the indication of the timing of the usage of the energy being within the first time interval.

2. The method of claim 1, wherein the indication of timing comprises one or more user interface elements comprising a timeline having an energy window corresponding to the first time interval.

3. The method of claim 1, wherein the indication of timing comprises a notification badge on a mobile device.

4. The method of claim 1, wherein the indication of timing comprises an audio notification.

5. The method of claim 1, wherein the indication of timing is presented in a home automation application.

6. The method of claim 1, wherein accessing generation source data comprises:
accessing a rate at which the energy provider generates renewable energy and non-renewable energy emissions generated by the energy provider.

7. The method of claim 1, wherein the forecasted generation source values comprise a first plurality of data points, and wherein determining the energy forecast comprises:
determining a first threshold rate for the forecasted generation source values;
determining each data point of the first plurality of data points that is less than the first threshold rate; and
determining a generation source time interval based at least in part on each data point of the first plurality of data points that is less than the first threshold rate, wherein the energy forecast is based at least in part on the generation source time interval.

8. The method of claim 7, wherein the forecasted grid condition values comprise a second plurality of datapoints, wherein each data point of the second plurality of data points is associated with a respective time point of the first time interval, and wherein determining the energy forecast further comprises:
determining a second threshold rate for the forecasted grid condition values;
determining each data point of the second plurality of data points that is greater than the second threshold rate; and
determining a grid condition time interval based at least in part on each data point of the second plurality of data points that is greater than the second threshold rate, wherein the energy forecast is based at least in part on the grid condition time interval.

9. The method of any of claim 7, wherein the forecasted price values comprise a third plurality of data points, and wherein determining the energy forecast further comprises:
determining a third threshold rate for the forecasted price values;
determining each data point of the third plurality of data points that is less than the third threshold rate; and
determining a price time interval based at least in part on each data point of the third plurality of data points that is less than the third threshold rate, wherein the energy forecast is based at least in part on the price time interval.

10. The method of claim 9, wherein the method further comprises:
determining that the generation source time interval overlaps the grid condition time interval over a second time interval; and
causing, by the computing system, the energy forecast to be presented based at least in part on the overlap, the energy forecast including the indication of timing for usage of energy that is provided by the energy provider, the indication of the timing of the usage of the energy being within at least one of the first time interval or the second time interval.

11. The method of claim 10, wherein the method further comprises:
determining that the generation source time interval overlaps the price time interval over a third time interval; and
causing, by the computing system, the energy forecast to be presented based at least in part on the overlap, the energy forecast including the indication of timing for usage of energy that is provided by the energy provider, the indication of the timing of the usage of the energy being within at least one of the first time interval, the second time interval, or the third time interval.
